(19) United States
(12) Patent Application Publication
(10) Pub. No.: US 2010/0089248 A1
(43) Pub. Date: Apr. 15, 2010

(54) Convection grill

(76) Inventor: Edward Michael Jones, Stratford, CT (US)

Correspondence Address: Edward Michael Jones, 200 Morningside Terrace, Stratford, CT, 06614, US

(21) Appl. No.: 12/287,531

(22) Filed: Oct. 10, 2008

(51) Int. Cl. A47J 37/00

(52) U.S. Cl. 99/444

(57) ABSTRACT

A portable electric grill for that has utilizes an electric fan to draw smoke and cooking odors through a filter then redirects and circulates the cleaner hot air around food to create convection heating thereby improve and making faster the cooking process. The grill can be used for indoor or outdoor use. It has a removable lid that when in the down position it provides the circulation of the hot air throughout the grill. It has a removable grill plate that either sits on top of heating elements or has heating elements imbedded in the grill plate. The grill plate is used for searing various foods and then allowing the convection air to cook the foods throughout. It has controls for regulating temperature, cooking time and fan speed. It has a pull-out grease tray to catch and dispose of drippings from cooking food. The filter is removable for cleaning.

### REFERENCES CITED [REFERENCED BY]

U.S. Patent Documents

| US 7,301,128 B2 | November 2007 | Li, Robertson |
|---|---|---|
| US 6,747,250 B1 | June 2004 | Cha |
| US 6,363,842 B1 | April 2002 | Lin |
| US 6,227,189 B1 | May 2001 | Dougherty |
| 6,131,559 | October 2000 | Norris |
| 5,345,923 | September 1994 | Luebke |

### CROSS REFERENCE TO RELATED APPLICATIONS

Not applicable

### STATEMENTS REGARDING FEDERALLY SPONSORED RESEARCH OR DEVELOPMENT

Not Applicable

### REFERENCE TO MICROFICHE APPENDIX

Not applicable

### BACKGROUND OF THE INVENTION

1. Field of Invention

The present invention relates to a portable electric grill that has been improved to provide quicker faster cooking while eliminating smoke and food odors while not sacrificing the taste of grilled food.

2. Description of Prior Art

U.S. Design Pat. D389777 ornamental design for tree stand.

There are several U.S. patents that address either convection cooking or filtering smoke from cooking. None of them combine the two activities into one product using a single fan. In one example U.S. Pat. No. 7,301,128 B2 addresses the removal of smoke in conjunction with a fan located below the cooking surfaces and between the folding cooking surfaces. But it is an open grill with no convection heating present to improve cooking or grilling. With the present invention which incorporates a domed lid roasting is possible where it is not with all open grills. In another example of smoke removal U.S. Pat. No. 6,363,842 B1 has a telescoping hood that sits on a stanchion above the grill plate that drawing smoke up through the filter but it does not have a convection air flow feature as does the present invention.

In another example U.S. Pat. No. 6,747,250 B1 has a heating element attached to a fan that blows hot air down on food creating convection cooking but does not filter smoke from the air or does it provide for a grill that cooks and sear food from the bottom. It acts as an oven as opposed to the present invention that cooks like a grill. In U.S. Pat. Nos. 6,227,189 B1, 6,131,559, 5,345,923 have to do with commercial ovens that provide convection cooking.

In an example U.S. Pat. No. 4,043,663 provides for a fan and duct work to draw smoke and odor away from the cooking surface but does not provide for using the same heating air for convection cooking as in the present invention.

### SUMMARY OF THE INVENTION

The present invention relates to an portable electric grill which may also be used indoors or outdoors for grilling or roasting with removable dome lid and which significantly reduces smoke that is created during cooking. It utilizes a built in fan that draws the smoke created from cooking food through a filtering device. With the lid on and closed, the filtered and heated air is then channeled through an air duct and directed back to the top the grill through the aid of a deflective shield mounted on the inside of the lid. This heated air circulates around the food sitting on a grill plate thereby cooking the food and locking in its flavor and juices while the fat drips away providing a healthier and more flavorful meal. The convection cooking reduces the cooking time and saves energy.

Grill Housing—shape can be rectangular, square, round or oval and made from metal, stainless steel or plastic or any combination there of. It supports and houses heating elements, grill/griddle plate, or heating element embedded grill plate, drip tray, drip pan, grill rack, lid/cover filter assembly, fan and controls. It has orifices to draw smoke, odors and hot air from the grilling area and force the cleaner hot air back to where the food is cooking on the grill plate thereby filtering the internal air and providing convection cooking.

Filter System—the fan which can mount at the top, bottom, or back draws smoke and odor through a series of charcoal and grease filters. After filtering the air it directs the heated cleaner air back onto the food to reduce cooking time. The filtering system would comprise of a at least a charcoal filter and grease filter enclosed within a metal or plastic frame and would be positioned between the fan intake and the food that is cooking and could be partially below the food and above the food. The filter frame will completely remove by sliding in and out for cleaning

Fan—The fan is mounted on the rear or bottom of the housing or could be mounted to the lid/cover. The fan system draws smoke away from the cooking food, filters the smoke and sends the heated air back down on the food to create a convection cooking effect from the circulation of air which in turn thereby assists in the reduction of cooking time.

Heating System—The system will utilize either exposed calrod elements with grease deflectors with a grill rack, or an aluminum grill plate that sits on top of the calrod elements or a cast aluminum grill plate with the calrod elements cast inside. Regardless of the heating method, the heat can be concentrated towards the front of the grill or the back by simply turning off the heating elements by use of the temperature controller. The reason for the providing the concentration of heat in one area is to sear the food that is being cooked and then removing it from direct heat so the filtered convection air via the fan can cook the food to completion without burning it.

Controls—There will be three to four controls: a thermostat for control heat by reducing wattage to the heating elements, an element control switch that activates and deactivated the heating elements, a ON/Off-Low-High switch for the fan, and a timer to time cooking. The controls may be fixed to the housing or a module that removes to facilitate cleaning of the housing.

Grill Rack/Grill Plate/Embedded Heating Element/Griddle—The Grill Rack, if this method is utilized, would be a wire, stamped or die cast (metal or aluminum) which would sit above the calrod heating elements that have a small metal reflector immediately above them to deflect grease spatters from the calrods which could cause flare-ups. The Grill Plate would be either stamped or die cast aluminum and sit directly on the heating elements. The Grill Plate would have raised ribs for searing and sloped towards the center where there would be a hole to drain grease into grease tray located beneath it. The Grill Plate may have many slots built in to provide added grease drainage augment the air flow for better convection cooking and improved smoke and odor reduction. It would be removable for cleaning. The die cast Embedded Heating Element would be die cast with the heating elements die cast into the Grill Plate and the configuration would be similar to the aforementioned Grill Plate configuration i.e. center drain hole and slots. The Embedded Heating Element Grill Plate would be removable for cleaning. A flat griddle which may be stamped aluminum or die cast aluminum and could either set on the elements or have Embedded Elements would be an additional cooking device.

Drip Tray/Drip Pan—Depending on the method of heating elements utilized there may be a combination of a drip pan and drip tray. With the exposed calrod elements a drip pan and tray may be necessary. The pan would be located above the tray and would slope from all directions toward a center hole which would allow grease to drain away from the heating elements. If a Grill plate with or without the Embedded Elements is utilized only the Drip Tray would not be necessary. Both the Drip Pan and The Drip Tray would be removable for cleaning. They would slide in and out on runners and could be position on the front, back or either side.

Lid/Cover—The Lid/Cover would be mounted to the housing with hinges and be removable for cleaning. It will have a dome shape to promote better air flow for convection cooking and provide enough space for roasting. It may or may not have a view window. It would have a deflector for the hot air that is being forced up into the grill area to direct towards the food being cooked and the deflector would help keep the top of the lid cooler.

### BRIEF DESCRIPTION OF THE DRAWINGS

FIG. 1 a perspective view of the invention illustrating the overall convection grill configuration

FIG. 2 a side view which provides a perspective of the various parts and direction of air flow

FIG. 3 a perspective of a grill plate and heating elements

FIG. 4 a front view of convection grill

### DETAILED DESCRIPTION OF THE PREFERRED EMBODIMENT

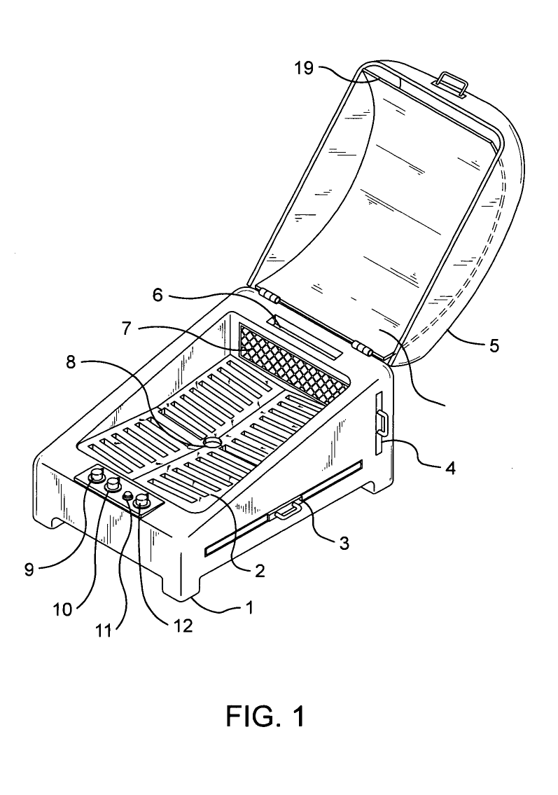

Convection grill in FIG. 1 which depicts the grill housing 1, which is the main frame support for all the other parts. It is shown with the lid 5, in the open position to expose some of the important parts of the invention.

as shown in FIG. 1 the grill plate 2, has raised edges and slopes inward towards the center grease hole drain 8, as previously mentioned the grill plate may have several oblong openings in it to augment air flow.

as shown in FIG. 1 there is an a forced air outlet orifice 6, located at the top rear of the housing in which the filtered air is re-circulated back into the cooking surface. The air as it exits the air outlet orifice is re-directed back towards the grill plate by means of a deflective shield 19, mounted to the inside of the lid.

as shown in FIG. 1 there is a filter 7, located at the rear inside housing which filters the air as it is drawn though it by the fan 13 which for the purpose of this illustration is located on the rear of the housing.

as shown in FIG. 1 a grease tray 3 is shown on the right side of the housing which is removable for cleaning. Also depicted is the filter opening 4 which allows for the insertion and removal of the filter 7.

as shown in FIG. 1 a fan control 9, for adjusting the speed of the fan 13, a temperature control 10, for adjusting the heat of the heating elements 14, or for deactivating or activating any or all elements, an indicator light 11, which shows that the heating elements are activated, and a timer 12 to time the cooking of food and to shut the unit off when the time has cycled.

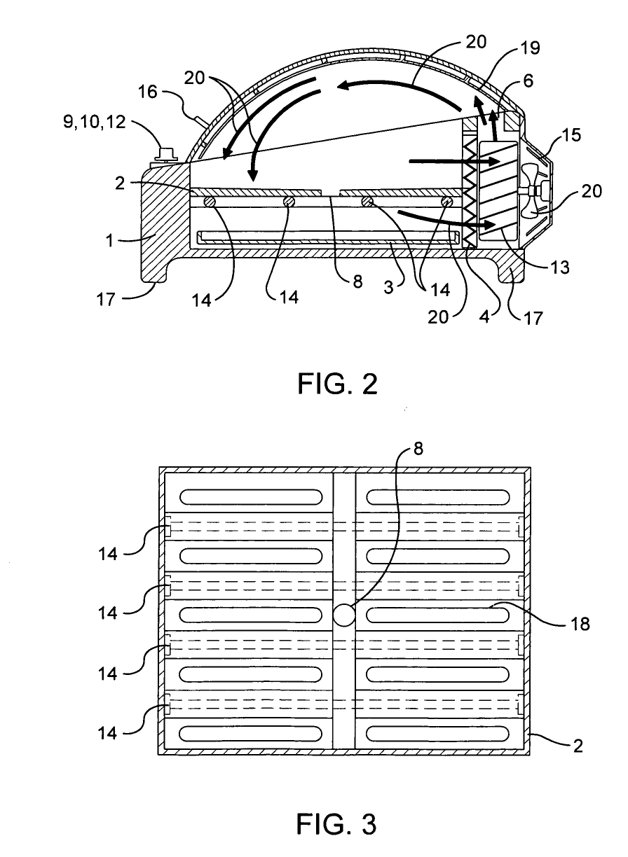

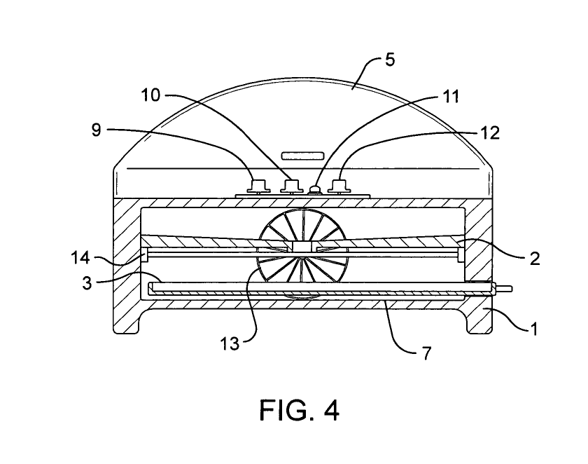

as shown in FIG. 2 a side view depicting the air flow 20, of smoke or odors being drawn through the filter and into the fan and redirected upwards through the orifice air flow outlet 6, against the deflector 19 and back onto the grill. The draw of the fan draws the smoke down below through the vents located in the grill plate 2, and also directly back across the grill top of the grill plate 2. It also depicts the location of the filter door 4.

as shown in FIG. 2 the position of the fan in the housing 13, although it could mounted on the side, top, or bottom and achieve the same results. A rear motor cover is vented which allows a motor cooling fan to draw in cool air from the outside to cool the motor.

as shown in FIG. 2 the slope and position of the grill plate 2, and the position of the heating elements 14.

as shown in FIG. 2 the dome lid 5 which provides for room to roast food and provides even distribution of the heated air flow 20. The lid handle 16 is also depicted.

as shown in FIG. 2 the location of the grease tray 3 in relation to the heating elements 14 and grill plate 2.

as shown in FIG. 2 a depiction of the location of the legs 17, the controls 9, 10, & 12.

as shown in FIG. 3 a removable grill plate 2, depicting the grease hole 8, as well as air/grease slots 18.

1. A portable electric grill comprising: a housing body that holds a fan, a removable filter, a grill plate with grease drain, grease tray, removable lid, heating elements, controls for temperature, time, fan speed and indicator light.

2. A portable electric grill of claim 1 wherein a fan is mounted to the grill housing and serves a dual purpose which is to filter air to remove smoke and cooking odors and then to circulate the cleaned air around the food in order to improve the cooking characteristics.

3. A portable electric grill of claim 2 wherein the fan draws the smoke and odor into the fan through a filter and redirects the clean air back onto the food creating convection cooking.

4. A portable electric grill of claim 1 wherein the grill plate sits atop heating elements or has heating elements permanently affixed to it that transfers the heat to cook food.

5. A portable electric grill of claim 4 wherein a grease drain is located in the center of the grill plate or consist of several slots in the grill plate with the grill plate angled towards the center to capture the grease and dispose of it in the grease tray.

6. A portable electric grill of claim 4 wherein the grill plate is lower in the center than the sides. The grill plate is manufactured so that it angles in towards the center providing improved grease run-off into the grease tray.

7. A portable electric grill of claim 1 & 5 wherein the grease tray is located in the housing directly below the grill plate to capture drippings from food. The grease tray slides in and out of the housing for easy cleaning.

8. A portable electric grill of claim 1 wherein the filter is comprised of a frame which holds various materials that reduce or eliminates smoke and food odors.

9. A portable electric grill of claim 6 & 3 wherein the filter slides in and out of the housing for cleaning and is positioned in front of the intake for the fan

10. A portable electric grill of claim 1 wherein the lid is domed shaped to help promoted the better flow of heated air thereby providing better convection cooking

11. A portable electric grill of claim 10 wherein the lid is removable for cleaning. And it is domed shaped that allows for roasting.

12. A portable electric grill of claim 1 wherein grill has a control to regulate the temperature of heating elements or to turn on or shut-off some or all of the heating elements.

13. A portable electric grill of claim 1 wherein there is a control to regulate the fan speed or turn it off.

14. A portable electric grill of claim 1 wherein there is a timer control that activated the grill and deactivates it as well as time foods being cooked.
